(19) United States
(12) Patent Application Publication
(10) Pub. No.: US 2025/0013738 A1
(43) Pub. Date: Jan. 9, 2025

(54) METHOD FOR ENFORCING INTEGRITY CONDITIONS OF A FIRST CONTAINER-BASED APPLICATION

(71) Applicant: Siemens Aktiengesellschaft, München (DE)

(72) Inventor: Christian Knierim, München (DE)

(21) Appl. No.: 18/712,399

(22) PCT Filed: Nov. 8, 2022
(86) PCT No.: PCT/EP2022/081106

§ 371 Date: May 22, 2024

(30) Foreign Application Priority Data
Nov. 30, 2021 (EP) 21211418.5

(51) Int. Cl. G06F 21/53; G06F 21/62

(52) U.S. Cl. CPC G06F 21/53; G06F 21/629; G06F 2221/2141

(57) ABSTRACT

A method is provided for enforcing integrity conditions of a first container-based application with respect to all second container-based applications running in a shared runtime environment of a host system, the method including: assigning a first integrity standard including at least one requirement with regard to a second application; receiving a first piece of provisioning information and the first integrity standard from a user of the first application in the runtime environment, before the start of a first container instance of the first application; verifying the first piece of provisioning information with respect to a second integrity standard verifying the second pieces of provisioning information for each of the second applications with respect to the first integrity standard; reporting to the user a violation; and carrying out an operation to rectify the at least one violation and running the first container instance in the runtime environment.

This application is a national stage of PCT Application No. PCT/EP2022/081106, having a filing date of Nov. 8, 2022, which claims priority to EP application Ser. No. 21/211,418.5, having a filing date of Nov. 30, 2021, the entire contents both of which are hereby incorporated by reference.

### FIELD OF TECHNOLOGY

The following relates to methods for enforcing integrity conditions of a first container-based application in relation to (all) at least one second container-based application that are being executed in a common runtime environment of a host system.

### BACKGROUND

Container virtualization is a method in which several instances of an operating system are able to utilize an operating-system kernel of a guest computer in isolation from one another. Software containers, hereinafter called “containers” for short, consequently constitute a lightweight type of virtualization of a runtime environment on a guest computer, also called a host system, and encapsulate an application being run in a container from the underlying host system. Applications have in the meantime been implemented in many fields such as, for instance, in industrial automation and in process control, but also for applications in transport systems or vehicles by containers.

In order to be able to start a container on the host system, a container image is needed that contains, in addition to an application program, also called application software, the binary programs and libraries required for the application program. On the host system, a container, more precisely, a container instance is created from the container image and is executed in a runtime environment such as Docker, for instance. If need be, for instance in the event of intensified calling of the application by users, further container instances on the same host system or on a different host system, which may also take the form of a virtualized hardware resource, can be generated from the same container image and executed. In the following, the terms “container instance” and “container” will be used synonymously.

When the container instance is being started, execution authorizations, also called privileges, are assigned to the processes named in the container instance, and an integration of devices or of other file-system resources of the underlying device is also agreed upon. In order to avoid attacks on the host system by the application, these execution authorizations can be restricted, so that merely the rights required for the running of the application are allocated to the container.

Ordinarily, a containerized application does not consist of a single isolated container instance but is made available as an overall application by reason of a microservice-based architecture in conjunction with other container instances. An interaction of several container instances, or an interaction of the virtual infrastructure thereof and, in particular, the runtime authorizations and process authorizations thereof, is defined in, amongst other things, an item of deployment information. In the non-orchestrated field, a Docker Compose format specified by Docker can, for instance, be used for this purpose.

In SIEMENS AG CHRISTIAN PETER FEIST DE-MÜNCHEN ET AL: “Mechanismus zum Schutz von Shared Volumes auf Edge Geräten”, PRIOR ART PUBLISHING GMBH, MANFRED-VON-RICHTHOFEN-STR 9, 12101 BERLIN GERMANY, Vol. www.priorartregister.com, Nov. 3, 2021 (2021-11-03), pages 1-7, XP007024416, it is disclosed that the volumes needed by an application, that is to say, memory resources of a host system are specified in a configuration file or manifest file. An app runtime environment examines whether volumes have been specified to which the application should not have access. The starting of the application can be prohibited in the event of an inconsistency.

Different creators are able to create container images, with the aid of which an operator is able to start container instances in his/her runtime environment. In this connection, there is a risk that container instances of an application that are specified in an item of deployment information will read out or change confidential data or runtime configurations pertaining to another application or item of deployment information. Different creators might also use the same container image, but the container instances might assume responsibility for different tasks. For instance, a database container that is run twice on one platform in different applications might be used for different tasks.

### SUMMARY

An aspect relates a method in which integrity requirements of an application to be newly started can be imposed on other applications already being executed, or on the item of deployment information thereof, and these requirements can be evaluated and enforced, and the new application can be started.

According to a first aspect, embodiments of the invention relate to a method for enforcing integrity conditions of a first container-based application in relation to all second container-based applications that are being executed in a common runtime environment of a host system, comprising:
assigning a first integrity guideline to a first item of deployment information pertaining to the first application, the first integrity guideline including at least one requirement with respect to the at least one second application, and the first item of deployment information including at least one property of the first application,
receiving the first item of deployment information and the first integrity guideline from a user of the first application in the runtime environment, prior to the starting of a first container instance of the first application,
   checking the first item of deployment information in relation to a second integrity guideline which has been assigned to a second item of deployment information pertaining to the second application, for each second application,
   checking the second item of deployment information for each of the second applications in relation to the first integrity guideline,
   reporting at least one violation, including the properties in the first item of deployment information that violate at least one of the second integrity guidelines, and including the properties in the second item of deployment information that violate the first integrity guidelines, to the user,
   carrying out an operation for eliminating the at least one violation, and
upon successful elimination of the at least one violation, executing the first container instance in the runtime environment,
wherein the first item of deployment information comprises a standard configuration and at least one fallback configuration of the runtime environment for the first application, and for the purpose of eliminating the at least one violation the first application is configured dynamically by the runtime environment in accordance with one of the fallback configurations, or
wherein upon the occurrence of the at least one violation the applications causing the at least one violation are deleted automatically, the applications to be deleted being one or more second applications.

Also, when starting more than one container instance, the method can be carried out for the several container instances. The integrity guideline makes it possible to impose requirements on the configuration of other applications and the container instances thereof, to identify violations of the requirements, and to instigate measures. Access authorizations and process authorizations of other container instances have been stored in the integrity guidelines. For instance, in the runtime environment of the host system, for instance, in an industrial control unit a check can consequently be made to prevent the first application which is to be newly started from obtaining privileges that allow the first application, or its user, to read out or modify data pertaining to the second application which is already being executed in the runtime environment of the host system.

Moreover, by the method a check is likewise made as to whether the deployment information and privileges or configuration properties, contained therein, of the first application to be started conform to the second integrity guideline of each second application that is already being executed on the host system. Consequently, the mutual integrity of the applications is ensured. The first integrity guideline may additionally include requirements with respect to the first item of deployment information for the first application. By virtue of the assignment of the integrity guideline to the item of deployment information, individual integrity requirements can be defined for each installation of the first application.

By virtue of the implementation of the method prior to the starting of each first container instance pertaining to the first application, the mutual integrity can be examined and guaranteed also during the runtime between the configuration of the first application obtaining at this time and the configuration of the second application obtaining at this time.

In an embodiment, the first integrity guideline and the first item of deployment information are made available by a creator of the first item of deployment information.

The creator of the first item of deployment information is, for instance, a developer of the application. The creator of the first application can, consequently, himself/herself establish integrity guidelines specifically for each first application and/or for the runtime environment and/or for the type of the host system on which the application is being executed, and/or of the operator of the host system, and can consequently make them flexible. In contrast to the creator, the user of the application is the person who is using the first application.

In an embodiment, the first item of deployment information is additionally checked against a runtime-integrity guideline of the runtime environment, and a violation, including the properties of the first item of deployment information that violate the runtime-integrity guideline IR0, is reported to the user.

This makes it possible to specify requirements of the runtime environment oneself and to check and enforce these requirements when a first container instance is being started. The runtime-integrity guideline is carried out before the checking of the first and second integrity guidelines.

In an embodiment, the second item of deployment information and the second integrity guideline have been stored persistently on the host system.

This makes it possible to carry out the checking at any time when a first container instance is to be started. A first container instance can be started not only when the application is being started for the first time in the runtime environment, but can be started at a later time, depending on the functional range and functional sequence within the application. Also, for reasons of load, for instance, depending on the number of calls of the application, a further first container instance can be started, with any time-interval after the starting of the first application.

In an embodiment, the first item of deployment information and the assigned first integrity guideline are stored on the host system after the elimination of the violation.

This makes it possible to make the first integrity guideline and the first item of deployment information available for the checking of the integrity guidelines of applications to be started subsequently. If the application, or the container instance, is started in an orchestrated environment, the first item of deployment information and the assigned first integrity guideline are stored, for instance in an orchestration unit.

In an embodiment, the first integrity guideline (IR1) is assigned to the first item of deployment information (BI1, in that the first integrity guideline (IR1) is arranged as an integral part of the first item of deployment information (BI1), and/or in that a common digital signature is created with the aid of the first integrity guideline (IR1) and the first item of deployment information (BI1), or in that a unique identifier is allocated to the first integrity guideline (IR1) and to the first item of deployment information (BI1).

The item of deployment information is signed jointly with the integrity guideline; it is an integral part of the deployment guideline or can be referenced via unique descriptors such as the name of the app or of the allocated unique label.

In an embodiment, the first integrity guideline contains at least one requirement imposed on the second application with respect to at least one of: privileges for performing operations, access authorizations to predetermined file-system paths, a predetermined signature and/or a predetermined creator of the application.

This makes it possible to authorize and to isolate container instances differently by virtue of an allocation of privileges or the withdrawal thereof. In this way, the integrity requirements can be made available on the basis of the secure identity of the creator or also on the basis of the integrity of the content of the first or second integrity guideline or deployment unit.

In an embodiment, each of the requirements in the first integrity guideline is valid for the second application as a whole, or valid for at least one of the second container instances of the second application, or valid for both the first container instances and the second container instances.

This makes it possible to define requirements flexibly for the entire second application, for merely parts—that is to say, individual second container instances of the second application—or even for the entire first container instances or parts thereof in the first integrity guideline.

In an embodiment, a range of validity of the first integrity guideline is established by a skip-mark that has been assigned to at least one container image or to at least one second item of deployment information.

This makes it possible to tag individual container images and to carry out the checking of the integrity guidelines when a first container instance is being started that was created from the tagged container image. Consequently, a checking of special container images containing processes relevant to security, for instance is possible.

In an embodiment, the violation is indicated to the user via a user interface, and an instruction for eliminating the violation is received by the user.

The result of the checking can consequently be indicated to the user. The user can decide interactively whether the at least one first or second application causing the conflict is to be deleted together with the integrity guideline made available.

In an embodiment, at least one predefined rule for eliminating the violation, and instructions resulting therefrom, are contained in the runtime environment.

This enables an automatic elimination of the violation. This can be used, in particular, in the case of frequently occurring similar violations, and reduces the effort in terms of time and personnel when making the application available.

In an embodiment, in an application-specific deployment guideline the elimination of the violation is made available via the user interface or via the predefined rule and further modalities for eliminating the violation in the runtime environment.

This enables an elimination, adapted to the respective application, of the reported violations.

In an embodiment, the fallback configuration includes fewer properties with respect to the privileges for performing operations, access authorizations to predetermined file-system paths, the predetermined signature or the predetermined creators in comparison with the standard configuration.

This makes it possible to start the first application despite a reported violation, and to run the first application with fewer privileges and such like.

In an embodiment, the checking, reporting and eliminating are carried out by an orchestration unit in an orchestrated environment.

This makes it possible to examine the integrity guideline also in an orchestrated environment when first container instances are being started.

A further aspect of embodiments of the invention relates to a system for enforcing integrity conditions of a first container-based application in relation to all second container-based applications that are being executed in a common runtime environment of a host system, including an assignment unit that has been designed:
to assign a first integrity guideline to a first item of deployment information pertaining to the first application, the first integrity guideline including at least one requirement with respect to the at least one second application, and the first item of deployment information including at least one property of the first application,
and the host system has been designed to execute the following steps:
receiving the first item of deployment information BI1 and the first integrity guideline IR11 from a user of the first application in the runtime environment, prior to the starting of a first container instance of the first application,
   checking the first item of deployment information against a second integrity guideline which has been assigned to a second item of deployment information pertaining to the second application, for each second application,
   checking the second deployment information for each of the second applications against the first integrity guideline,
   reporting at least one violation, including the properties of the first item of deployment information that violate at least one of the second integrity guidelines, and including the properties of the second item of deployment information that violate the first integrity guideline, to the user,
   carrying out an operation for eliminating the at least one violation, and
upon successful elimination of the at least one violation, executing the container instance in the runtime environment, wherein the first item of deployment information comprises a standard configuration and at least one fallback configuration of the runtime environment for the first application, and for the purpose of eliminating the at least one violation the first application is configured dynamically by the runtime environment in accordance with one of the fallback configurations, or
wherein upon the occurrence of the at least one violation the applications causing the at least one violation are deleted automatically, the applications to be deleted being one or more second applications.

In the system, restrictions for the runtime environment are made dependent on the first item of deployment information and on all the second items of deployment information made available, and on the assigned integrity guideline. Consequently, the restrictions for the runtime environment are no longer created in isolation and centrally across a platform but are adapted dynamically as a function of the installed applications.

A further aspect of embodiments of the invention relates to a computer program product (non-transitory computer readable storage medium having instructions, which when executed by a processor, perform actions) which is capable of being loaded directly into a memory of a digital computer, comprising program-code parts that upon execution of the program-code parts by the digital computer cause the latter to carry out the steps of the method.

Unless otherwise stated in the following description, the terms “receive”, “check”, “report”, “carry out” and such like relate preferentially to actions and/or processes and/or processing steps that change and/or generate data and/or convert the data into other data, in which connection the data are represented or may be present, in particular, as physical quantities, for instance as electrical impulses. In embodiments, the system and the assignment unit and host systems contained therein may include one or more processors. In embodiments, the system has been designed to carry out each described step of the method.

A computer-program product-such as, for example, a computer-program means can be made available or delivered, for instance, as a storage medium, such as, for example, a memory card, a USB stick, a CD-ROM, a DVD or even in the form of a downloadable file from a server in a network. This can be done in a wireless communication network, for example by the transfer of an appropriate file to the computer-program product or to the computer-program means.

### BRIEF DESCRIPTION

Some of the embodiments will be described in detail, with reference to the following figures, wherein like designations denote like members, wherein:

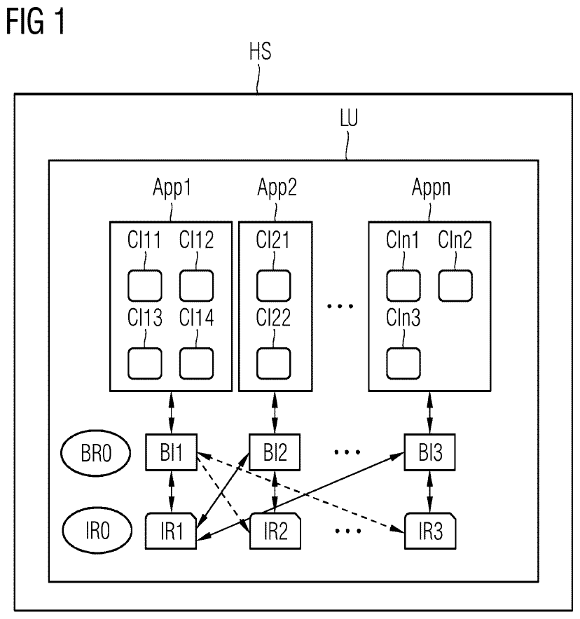

FIG. 1 shows several containerized applications with, respectively, an assigned integrity guideline according to embodiments of the invention, in schematic representation;

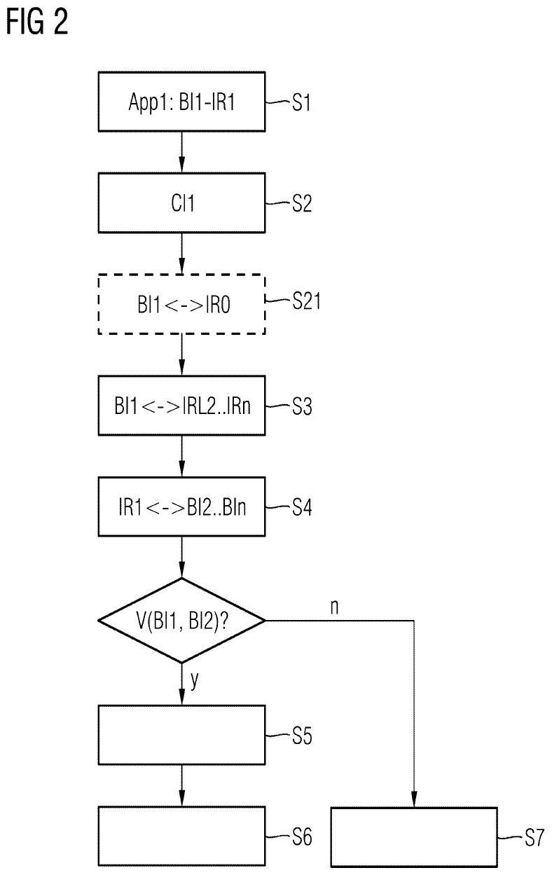

FIG. 2 shows an exemplary embodiment of the method, as a flowchart; and

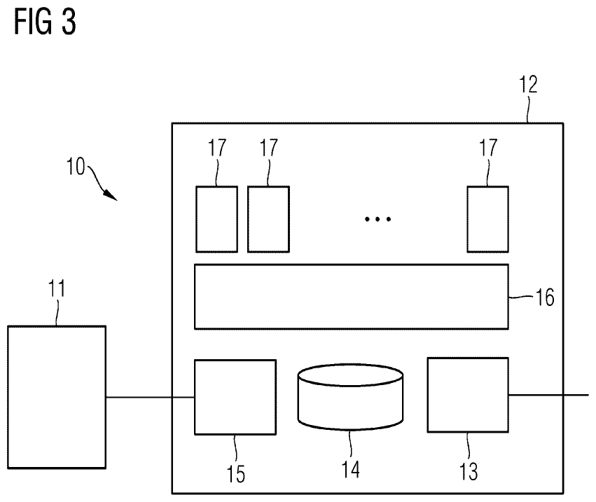

FIG. 3 shows a first exemplary embodiment of the system, in block representation.

### DETAILED DESCRIPTION

Software applications, for instance in the industrial environment, are being executed as container-based applications by software containers in a runtime environment of a host system, for instance in a control unit. Several container-based applications are frequently run on the host system. In order to prevent a container instance that is being used in different applications and that is consequently specified in various items of deployment information from being able to read out or change confidential data or runtime configurations pertaining to one of the other applications or items of deployment information, integrity conditions are imposed on the container instance as follows. In the following, container-based applications will be designated as “applications” for short.

In embodiments, the method for enforcing integrity conditions will be described with reference to FIGS. 1 and 2.

In the following, an application that is already being executed in a runtime environment will be designated as a second application. A container instance that has been assigned to one of the second applications and that makes available at least a part of the functionality of the second application will be designated in the following as a second container instance. If an application is not made available by a single container instance but is implemented by a network consisting of several container instances, for instance in the case of a microservice-based application architecture, a second application includes more than one second container instance.

FIG. 1 shows a runtime environment LU which is made available on a host system HS. At least one second application App2, . . . , Appn is already being executed in the runtime environment LU. The second applications App2, . . . . Appn are made available by, respectively, at least one second container instance CI21, CI22, . . . , CIn1, CIn2, CIn3. An item of deployment information BI2, . . . , BIn has been assigned to each second application App2, . . . . Appn. In each of the items of deployment information BI1, BI2, . . . , BIn, authorizations are defined that define the interaction of the container instances CI21, CI22 and CIn31, . . . , CIn3, or the virtual infrastructure thereof. Consequently, in the items of deployment information BI2, . . . , BIn it is established how the individual container instances CI21, CI22 and CIn1, CIn2, CIn3 pertaining to the application communicate with one another. The items of deployment information BI2, BIn may be, for instance, a Docker Compose file of a Docker-based container runtime environment or, for instance, a Kubernetes YAML file in an orchestrated environment. In accordance with embodiments of the invention, an integrity guideline IR2, . . . , IRn has been assigned to each second item of deployment information BI2, . . . , BIn.

In order to be able to enforce integrity requirements for a first application App1 which is to be executed additionally in the runtime environment LU, in a first method step S1, see FIG. 1, a first integrity guideline IR1 is assigned to a first item of deployment information BI1 pertaining to the first application App1. The first integrity guideline (IR1) is assigned to the first item of deployment information (BI1), in that the first integrity guideline (IR1) is arranged as an integral part of the first item of deployment information (BI1), and/or in that a common digital signature is created with the aid of the first integrity guideline (IR1) and the first item of deployment information (BI1), or in that a unique identifier is allocated to the first integrity guideline (IR1) and to the first item of deployment information (BI1). The item of deployment information may, for instance, be signed jointly with the integrity guideline; it may be an integral part of the deployment guideline; or it may be referenced via unique descriptors such as the name of the application or of an allocated unique label.

The first integrity guideline IR1 includes at least one requirement with respect to the at least one second application App2, . . . , Appn, and the first item of deployment information BI1 includes at least one property with respect to a configuration of the first application App1.

If the first item of deployment information BI1 and the first integrity guideline IR1 are received in the runtime environment LU by a user of the first application App1, see method step S2, prior to the starting of a first container instance CI1 of the first application App1 the first item of deployment information BI1 is checked against a second integrity guideline IR2 which has been assigned to the second item of deployment information BI2 pertaining to the second application App2. This is carried out for each second application App2, . . . , Appn, see method step S3. Moreover, the second item of deployment information BI2, . . . , BIn for each of the second applications App2, . . . , Appn is checked against the first integrity guideline IR1, see method step S4.

If a violation of the first deployment guideline BI1 in relation to at least one of the second integrity guidelines IR2, . . . , IRn of the already executed second applications App2, . . . , Appn is ascertained in the course of the checking, and/or if a violation of the first integrity guideline IR1 in relation to at least one of the second deployment guidelines BI2, . . . , BIn is ascertained in the course of the checking, the at least one violation is reported to the user, see method step S5. In this connection, the properties in the first item of deployment information BI1 that at least one of the second integrity guidelines IR2, . . . , IRn violates, and the properties in the second item of deployment information BI2, . . . , BIn that the first integrity guideline IR1 violates, are communicated to the user. Subsequently an operation for eliminating the at least one violation is carried out, see S5.

If the violation was able to be eliminated successfully, the first container instance CI1 is executed in the runtime environment, see S6.

If no violation is ascertained in the course of the checking S3 of the first item of deployment information BI1 and the checking S4 of the first integrity guideline IR1, the container instance is executed in accordance with the specifications of the first item of deployment information BI1, see method step S7.

The first integrity guideline IR1 and the first item of deployment information BI1 are made available by a creator of the first item of deployment information BI1.

The basic idea of embodiments of the invention consists in the fact that for the first application App1, or for the first item of deployment information BI1, requirements can be imposed on other, second container instances or instances of other, second applications App2, . . . , Appn by the creator of the item of deployment information BI1. These requirements are collected in the first integrity guideline IR1, linked with the item of deployment information BI1, and checked and enforced by the runtime environment LU. The entire first item of deployment information BI1 is specified by the creator—for instance, the developer—of the first application App1. The first integrity rule IR1 may additionally contain requirements imposed on one's own, first container instances CI11, . . . , CI14.

If a runtime-integrity guideline IR0 for the runtime environment obtains, the first item of deployment information BI11 is checked against the runtime-integrity guideline IR0 of the runtime environment LU, and a violation, including the properties of the first item of deployment information that violate the runtime-integrity guideline IR0, is reported to the user, see method step S21. The runtime-integrity guideline IR0 is examined before the first integrity guideline IR1 is checked.

This means that as soon as a first container instance CI11, . . . , CI4 is to be started in the runtime environment LU a check is firstly made by the runtime environment LU, for instance with the aid of a plug-in, as to whether the execution of the first container instance CI11, . . . , CI4 violates a specified runtime-integrity guideline IR0 of the runtime platform and also other second applications App2, . . . , Appn that have been set up in the runtime environment.

The first integrity guideline IR1 contains at least one requirement imposed on the second application App2 with respect to privileges for performing operations. Privileges are special execution options. By the allocation of privileges, or by the withdrawal thereof, container instances can be authorized and/or isolated differently. Examples of this are an assignment of existing Linux namespaces and Kubernetes namespaces, Seccomp profiles and capabilities. By this, it is ensured that a second application App2, . . . , Appn cannot itself access the first application App1. Further requirements that are optionally contained in the first integrity guideline IR1 are access authorizations to predetermined file-system paths, a predetermined signature or a predetermined creator of the second application App 2, . . . , Appn.

Second container instances CI21, . . . , CIn3 may, for instance, not be privileged or must exhibit the signature predetermined in the first integrity rule, and consequently, for instance, stem from a certain developer of applications in order to receive certain rights. Second applications may, for instance, access defined paths only under certain conditions or may execute processes within the second container instance only as a non-privileged user.

The second item of deployment information BI1, . . . , BIn and the second integrity guideline IR2, . . . , IRn have been stored persistently on the host system, and the first item of deployment information BI1 and the assigned first integrity guideline IR1 are stored on the host system HS after the violation has been eliminated.

The requirements—for instance, restrictions—may apply to all the first and second container instances CI11, . . . , CIn3 or may apply only to the second container instances CI21, . . . , CIn3. Each of the requirements in the first integrity guideline IR1 is valid for the second application App2, . . . , Appn as a whole, or valid for at least one of the second container instances of the second application App2, Appn, or valid for both the first container instances CI11, CI14 and the second container instances CI21, CIn3. A range of validity of the first integrity guideline IR1 is established by a skip-mark that has been assigned to at least one container image CI11, . . . , CIn3 or to at least one second item of deployment information BI2, . . . , Bn. The restrictions may consequently apply to all the container instances CI11, . . . , CIn3 or only to the container instances of other apps. The range of validity may, for example, be restricted to individual container images and/or to specified labels that have been allocated either to the container images themselves or to the item of deployment information BI1, . . . , BIn.

Similar container instances—that is to say, container instances that stem from the same container image—can by this means be authorized differently within different applications. The first integrity guideline IR1 may also include one's own functions in which the creator of application App1 can also define his/her own conditions or requirements and is not dependent on the conditions, predefined by the container runtime environment LU, in the integrity guideline IR0 of the runtime environment.

For embodiments of the invention, it is assumed as a matter of principle that the container runtime environment and the underlying host are trusted. Moreover, the properties and features of the first deployment guideline BI1 and of the first integrity guideline IR1 apply in like manner to the second deployment guidelines BI2, . . . , BIn and to the second integrity guidelines IR2, . . . , IRn.

As soon as the first container instance CI1 is to be started in a runtime environment LU, a check is firstly made by the runtime environment LU, for instance with the aid of a plug-in, as to whether the starting of the first container instance CI1 violates a specified guideline of the runtime platform, for instance the runtime-integrity guideline IR0 and one of the integrity guidelines IR2, . . . , IRn of the second applications App2, . . . , Appn. In order to be able to identify which of the second integrity guidelines is being violated, the first deployment guideline BI1 has to be checked against all the already installed second integrity guidelines IR2, . . . , IRn. In this connection it is important that for the purpose of ascertaining the permission authorization the checking is not terminated upon the first violation of a second integrity guideline.

The first and second integrity guidelines may be predefined both in application-specific manner and in platform-specific manner—that is to say, globally by the operator of the platform. If violations of at least one of the integrity guidelines IR0, IR1, . . . , IRn are ascertained, the runtime environment LU reports back to the deployment system, or to the user, the requirements in the runtime-integrity guideline IR0 and/or the requirements in the second integrity rules IR2, . . . , IRn that are preventing the installation of the first container instance CI1 or even of the first application App1 as a whole. In this context, the deployment system is the orchestration unit that is able to carry out an automatic conflict resolution.

In the event of the violation of the platform-specific runtime-integrity guideline IR0, the installation of the first container instance is terminated. In the event of violations of application-specific second integrity guidelines IR2, . . . , IRn, the procedure is as described in the following:

In a first variant, it is indicated to the user via a user interface that the installation of the first container instance CI1 or of the first application App1 cannot be carried out. The requirements of the second integrity guidelines IR2, . . . , IRn that the first item of deployment information BI1 violates, and consequently prevent the installation of the first application, are indicated.

The user can then decide interactively whether the second applications causing the conflict, and the integrity guidelines assigned to these second applications, are to be deleted. Via the user interface, at least one instruction for eliminating the violation can optionally be received by the user. Examples of instructions are a deletion or a non-installation of the second applications that are generating the conflict.

The elimination of the violation is optionally made available via the user interface or via the predefined rule and further modalities for eliminating the violation in an application-specific deployment guideline BRO in the runtime environment LU.

In a second variant, at least one predefined rule for eliminating the violation, and instructions resulting therefrom, are contained in the runtime environment LU. The behavior upon the occurrence of a violation is consequently defined within the runtime environment LU. In this connection, it is possible that items of deployment information are prioritized differently, for example by reason of the signatures made available and the concomitant association with the creator of the application. For instance, applications that are made available by a predetermined creator A are installed with precedence. Upon the occurrence of a violation, the applications causing the violation are deleted automatically. With the deleted application, the integrity guideline stored for the application is also deleted. The application to be deleted may be one or more second applications App1, . . . , Appn, but may also be the first application App1.

The different variants can be defined in a deployment guideline BI0 in the runtime environment LU, or can be passed on as configuration parameters. Alternatively, it is also possible not to delete the applications causing the violation but only to mark them to be deleted and to carry them out within a secure transaction.

Moreover, a check is made, see method step S4, as to whether the first container instance CI1, to be newly installed, of the first application App1 is causing, by reason of the integrity guideline IR1, a conflict or violation for the already installed second container instances or the item of deployment information BI2, . . . , BIn thereof as soon as these second container instances have to be newly started. For this purpose, the integrity guideline IR1 of the first application App1 to be newly installed is used by the runtime environment LU and is compared against all the persistently stored items of deployment information BI2, . . . , BIn of the existing second applications App2, . . . , Appn. If a violation is established, the elimination of the conflict is undertaken with the aid of the variants described above. The conflict is resolved, in that the second applications having items of deployment information BI2, . . . , BIn that violate the first integrity guideline are deleted.

Once all the conflicts have been eliminated by deletion of the respective second applications, the first item of deployment information BI1 and the application-specific first integrity guideline IR1 are stored persistently within the runtime environment LU, and the first item of deployment information BI1 is newly started.

In one exemplary embodiment, the first item of deployment information BI1 comprises a standard configuration and at least one fallback configuration of the runtime environment LU for the first application App1, the fallback configuration comprising fewer properties with respect to privileges for performing operations, access authorizations to predetermined file-system paths, the predetermined signature or the predetermined creator in comparison with the standard configuration. For the purpose of eliminating the violation, the first application App1 is configured dynamically by the runtime environment LU in accordance with one of the fallback configurations.

In the first item of deployment information BI1 the first application App1 offers a desired standard configuration of the runtime environment LU for the first application App1. The fallback configuration includes settings that require fewer privileges than the standard configuration. In the course of the checking of the application-specific integrity guidelines IR2, . . . , IRn stored in the runtime environment LU, the runtime environment LU can choose individual fallback options as soon as a violation of at least one of the second integrity guidelines IR2, . . . , IRn of a second application App2 . . . , Appn is established. Since the checking and comparison of the first and second integrity guidelines IR1, . . . . IRn are carried out when first container instances CI1 are being started, in addition to the deletion of a conflict-causing second application the first application App1 can also be reconfigured dynamically and newly started by the runtime environment LU, so that the first container instance CI1 conforms to the runtime conditions of the remaining second applications App2, . . . , Appn.

The installation procedure of a first container instance CI1 and integrity guideline IR1, as well as the two described checks of the conformity test, are carried out within a secure transaction.

If an application is updated from an old version to a new version, a corresponding new version of the integrity guideline is not compared with the old version of the application.

The same method can be carried out also in an orchestrated environment instead of in a container runtime environment. In the orchestrated environment, applications and the container instances thereof are distributed to different host systems and are installed and managed by an orchestration unit. In this case, the orchestration unit assumes responsibility for the checking of the integrity guidelines IR1, . . . , IRn and the enforcement thereof.

FIG. 3 shows a system 10 for enforcing integrity conditions of the first container-based application App1 in relation to all the second container-based applications App2, . . . , Appn, which has been configured to carry out the steps of the method as described. In embodiments, the system 10 comprises an assignment unit 11, a host system 12, a user interface 13, a memory unit 14, a data interface 15 and a runtime environment 16.

The assignment unit 11 has been designed to assign the first integrity guideline IR1 to the first item of deployment information BI1 of the first application App1. The host system 12 and the runtime environment 16 arranged therein have been designed to receive the first item of deployment information BI1 and the first integrity guideline IR11 of the first application App1 from a user via the data interface 15. The runtime environment 16 has, moreover, been designed to carry out, prior to the starting of the first container instance CI1 of the first application, method steps S3, S4 for checking the first item of deployment information BI1 against a second integrity guideline IR2, for checking the second item of deployment information for each of the second applications against the first integrity guideline IR1. The runtime environment 16 has been designed to execute the first and second container instances CI11, . . . , CIn4, labeled generally in FIG. 3 by reference symbol 17.

The user interface 13 has been designed to report and to indicate violations ascertained by the runtime environment 16 to the user, and also to receive instructions from the user for eliminating the at least one reported and indicated violation.

The runtime environment 16 has been designed to perform the at least one operation for eliminating the at least one violation. Once the conflicts or violations have been eliminated, the runtime environment 16 executes the first container instance IR1.

The creator of an item of deployment information can, with the aid of the integrity guidelines made available by him/her, impose requirements on the configuration of other—that is to say, second-applications. A typical example of this is that a developer of the first application would like to prevent other applications on a host system, for instance on a device, from receiving elevated privileges and by this means from being able to read out or modify data pertaining to another second application. Runtime restrictions for a container runtime environment can be made dependent on the item of deployment information made available, and are consequently no longer created in isolation and centrally across a platform but can be adapted dynamically as a function of the installed applications. Existing restrictions made available centrally and across a platform can be defined in addition to the app-specific restrictions.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

The invention claimed is:

1. A method for enforcing integrity conditions of a first container-based application in relation to all second container-based applications that are being executed in a common runtime environment of a host system, comprising:
assigning a first integrity guideline to a first item of deployment information pertaining to the first application, the first integrity guideline including at least one requirement with respect to the at least one second application, and the first item of deployment information including at least one property of the first application;
receiving the first item of deployment information and the first integrity guideline from a user of the first application in the runtime environment;
prior to the starting of a first container instance of the first application, for each second application, checking the first item of deployment information against a second integrity guideline which has been assigned to a second item of deployment information pertaining to the second application,
checking the second item of deployment information for each of the second applications against the first integrity guideline,
reporting at least one violation, including the properties in the first item of deployment information that violate at least one of the second integrity guidelines, and including the properties in the second item of deployment information that violate the first integrity guideline, to the user,
carrying out an operation for eliminating the at least one violation, and
upon successful elimination of the at least one violation, executing the first container instance in the runtime environment,
wherein the first item of deployment information comprises a standard configuration and at least one fallback configuration of the runtime environment for the first application, and for the purpose of eliminating the at least one violation the first application is configured dynamically by the runtime environment in accordance with one of the fallback configurations, or
wherein upon the occurrence of the at least one violation the applications causing the at least one violation are deleted automatically, the applications to be deleted being one or more second applications.

2. The method as claimed in claim 1, wherein the first integrity guideline and the first item of deployment information are made available by a creator of the first item of deployment information.

3. The method as claimed in claim 1, wherein
the first item of deployment information is checked against a runtime-integrity guideline of the runtime environment and
a violation, including the properties of the first item of deployment information that violate the runtime-integrity guideline, is reported to the user.

4. The method as claimed in claim 1, wherein the second item of deployment information and the second integrity guideline have been stored persistently on the host system for each second application, and the first item of deployment information and the assigned first integrity guideline are stored on the host system after the elimination of the violation.

5. The method as claimed in claim 1, wherein the first integrity guideline is assigned to the first item of deployment information, in that the first integrity guideline is arranged as an integral part of the first item of deployment information, and/or in that a common digital signature is created with the aid of the first integrity guideline and the first item of deployment information, or in that a unique identifier is allocated to the first integrity guideline and to the first item of deployment information.

6. The method as claimed in claim 1, wherein the first integrity guideline contains at least one requirement imposed on at least one of the second applications with respect to:
privileges for performing operations,
access authorizations to predetermined file-system paths,
a predetermined signature,
a predetermined creator of the second application.

7. The method as claimed in claim 6, wherein each of the requirements in the first integrity guideline is valid for the at least one second application as a whole, or valid for at least one of the second container instances of the at least one second application or valid for both the first container instances and the second container instances.

8. The method as claimed in claim 1, wherein a range of validity of the first integrity guideline is established by a skip-mark which has been assigned to at least one container image or to at least one second item of deployment information.

9. The method as claimed in claim 1, wherein the violation is indicated to the user via a user interface.

10. The method as claimed in claim 1, wherein at least one predefined rule, for eliminating the violation, and instructions resulting therefrom are contained in the runtime environment.

11. The method as claimed in claim 9, wherein the elimination of the violation is made available via the user interface or via the predefined rule and further modalities for eliminating the violation in an application-specific deployment guideline in the runtime environment.

12. The method as claimed in claim 1, wherein the fallback configuration includes fewer properties with respect to privileges for performing operations, access authorizations to predetermined file-system paths, the predetermined signature or the predetermined creator in comparison with the standard configuration.

13. The method as claimed in claim 1, wherein an orchestration unit carries out the checking, reporting and eliminating in an orchestrated environment.

14. A system for enforcing integrity conditions of a first container-based application relation to all second container-based applications that are being executed in a common runtime environment of a host system, including an assignment unit which has been configured:
to assign a first integrity guideline to a first item of deployment information pertaining to the first application, the first integrity guideline including at least one requirement with respect to the at least one second application, and the first item of deployment information including at least one property of the first application,
and the host system has been configured to execute the following steps:
receiving the first item of deployment information and the first integrity guideline from a user of the first application in the runtime environment,
prior to the starting of a first container instance of the first application,
for each second application, checking the first item of deployment information against a second integrity guideline which has been assigned to a second item of deployment information pertaining to the second application,
checking the second items of deployment information for each of the second applications against the first integrity guideline,
reporting at least one violation, including the properties in the first item of deployment information that violate at least one of the second integrity guidelines, and including the properties of the second item of deployment information that violate the first integrity guideline, to the user,
carrying out an operation for eliminating the at least one violation, and
upon successful elimination of the at least one violation, executing the first container instance in the runtime environment,
wherein the first item of deployment information comprises a standard configuration and at least one fallback configuration of the runtime environment for the first application, and for the purpose of eliminating the at least one violation the first application is configured dynamically by the runtime environment in accordance with one of the fallback configurations, or
wherein upon the occurrence of the at least one violation the applications causing the at least one violation are deleted automatically, the application to be deleted being one or more second applications.

15. A computer program product, comprising a computer readable hardware storage device having computer readable program code stored therein, the program code executable by a processor of a computer system to implement a method as claimed in claim 1.
